(19) United States
(12) Patent Application Publication
(10) Pub. No.: US 2006/0237370 A1
(43) Pub. Date: Oct. 26, 2006

(54) Method of removing arsenic from potable water

(76) Inventors: Frank S. Craft SR., Memphis, TN (US); Michael D. Kelly, Memphis, TN (US)

Correspondence Address: WRIGHT, LINDSEY & JENNINGS LLP, 200 WEST CAPITOL AVENUE, SUITE 2300, LITTLE ROCK, AR, 72201-3699, US

(21) Appl. No.: 11/407,616

(22) Filed: Apr. 20, 2006

Related U.S. Application Data
(60) Provisional application No. 60/673,652, filed on Apr. 21, 2005.

(51) Int. Cl. C02F 1/28

(52) U.S. Cl. 210/681; 210/683; 210/668; 210/679; 210/670

(57) ABSTRACT

A method for removing arsenic from drinking water using a flexible modular absorption system. Modules containing adsorption media may be connected through a modular header system in various configurations, for example, lead-lag or parallel. Once the adsorption media is exhausted, the adsorption media may transported to a central facility for regeneration and then returned to the customer for reuse. The customer has no on-site operation, chemicals, secondary waste or sludge to manage. Off-site regeneration can be combined with responsible metals recovery and waste residuals disposal.

### CROSS-REFERENCE TO RELATED APPLICATIONS

This application claims the benefit of U.S. Provisional Application No. 60/673,652 filed Apr. 21, 2005, the disclosure of which is incorporated herein by reference.

### STATEMENT REGARDING FEDERALLY SPONSORED RESEARCH OR DEVELOPMENT

Not applicable.

### BACKGROUND OF THE INVENTION

1. Field of the Invention

The present invention relates to a method of removing arsenic from potable water supplies using a flexible modular absorption system, and in particular to such a method which uses modular regenerable adsorption vessels which may be connected in various configurations for flexibility and expandability.

2. Brief Description of the Related Art

By January 2006, municipalities will face a deadline for a new more stringent standard for the removal of arsenic from drinking water. The standard will fall from 50 ppb to 10 ppb. In many areas, naturally occurring arsenic-containing waters or contaminated groundwater is present. The conventional processes for the removal of arsenic rely on chemical processes which utilize the chemical reaction of arsenic with iron compounds. The most common techniques involve precipitation followed by coagulation and filtration. However, these conventional processes are less desirable for treatment of the small quantities of water required in many applications, for example, water flows of 1000-5000 gallons per minute or less. Furthermore, the water sources for many municipalities vary considerably during the year in terms of available flows and arsenic loadings.

Some new techniques for the treatment of water to remove arsenic also rely on the chemical reaction of arsenic with iron compounds, but the iron compounds, such as iron oxide or iron hydroxide, are used in the form of granules. The granules form an adsorption medium which removes the arsenic from the water. The drawback to these systems is that the granules tend to break up and produces fines which must be removed and discarded. It is suggested by recent reports that such fines may tend to leach arsenic when the fines are disposed in landfills.

Attempts to solve this problem have led to the production of various media where an iron compound is incorporated into or coated onto into a substrate. Examples are U.S. Pat. Nos. 6,790,363; 6,042,731; 6,203,709; 6,599,429; 5,369,072; and 6,200,482. U.S. Pat. No. 6,521,131 assigned to SolmeteX, Inc. discloses an absorbent material for removing mercury from water which comprises a mercury-selective chelating group bound in a porous resin. SolmeteX also offers a nanoparticle based selective resin for the removal of arsenic from water. This resin, called ArsenX^{np} is based on hydrous iron oxide particles and provides a durable substrate for an absorption medium.

Typically such arsenic adsorption media are provided in large tanks through which the water to be treated is passed. The media are placed in the tanks by sluicing the media in a quantity of water and the spent media are removed in the same fashion. The spent media is placed in smaller totes for return to a regeneration facility. Such arrangements may exacerbate the problem of fines when friable media is sluiced from one container to another. Alternatively, arsenic absorption media may be regenerated on-site but there are substantial drawbacks in that more operator attention is required, more chemical handling occurs, and there are potential environmental problems required by the disposal of wastes from the regeneration of the media.

The prior art methods for removing arsenic from drinking water therefore have a number of drawbacks, especially for smaller municipalities. The prior art methods require significant amounts of operator attention, expose the municipality to environmental liability through the handling of chemicals and wastes, are relatively inflexible in responding to natural variations in water flows and arsenic loading.

References mentioned in this background section are not admitted to be prior art with respect to the present invention.

### BRIEF SUMMARY OF THE INVENTION

The present invention addresses these problems by providing for a method for arsenic removal from potable water supplies the employs a flexible modular adsorption system. Vessels containing adsorption media may be connected through a modular header system in various configurations, for example, lead-lag or parallel, in order to have the flexibility to address variations in loading and flow. Preferably, the medium used in the modules for arsenic removal is SolmeteX regenerable arsenic removal media.

It is known to employ adsorption media to adsorb targeted ions onto regenerable selective adsorption media, including ion exchange and modified ion exchange media. When a vessel is exhausted, it can be disconnected from the system, transported with the exhausted (loaded) adsorption media to a central facility for regeneration and then returned to the customer for reuse. The media is contained in the vessel and in not sluiced out of the vessel into separate containers, thus avoiding potential damage to the media and the production of fines. The customer, for example, a municipality, thus avoids on-site operation, and the management of chemicals, secondary waste or sludge. Off-site regeneration can be combined with responsible metals recovery and waste residuals disposal to minimize environmental concerns.

The modular system of the present invention allows such centralized regeneration and waste disposal techniques to be applied to arsenic removal. Modular systems provide simple, cost-effective, flexible and easily expandable solutions to the problem of arsenic removal. When the adsorption media is exhausted, palletized vessels with media may be shipped to a central facility for media regeneration, equipment inspection and maintenance. Modules can be provided in various sizes. Multiple modules can handle a wide range of flow rates from 100 GPM to >1,000 GPM.

The advantages of the present invention are that it is user friendly, environmentally sound, and cost effective for arsenic removal.

### BRIEF DESCRIPTION OF THE SEVERAL VIEWS OF THE DRAWINGS

FIG. 1 is an elevation view of a palletized modular vessel comprising a vessel for containing arsenic absorption media.

FIG. 2 is an elevation view of a pair of the modular vessels of FIG. 1 showing modular inlet and outlet headers and piping for flexibly connecting the modular vessel.

FIG. 3A is a schematic diagram of the pair of modular vessels of FIG. 2 showing valving for connecting the modular vessels in various configurations.

FIG. 3B is a table showing the operation of the valves of FIG. 3A to connect the modular vessels in parallel, lead-lag (serial) or stand-alone configurations.

FIG. 4A is a schematic diagram of the pair of modular vessels of FIG. 2 showing a modular backwash header in addition to modular inlet and outlet headers and further showing valving for connecting the modular vessels in various configurations.

FIG. 4B is a table showing the operation of the valves of FIG. 4A to connect the modular vessels in parallel, lead-lag (serial) or stand-alone configurations and also showing the operation of the valves to backwash the vessels.

FIG. 5 is a perspective view of a assemblage of several pairs of modular vessels of the present invention showing the connection of adjacent modular inlet and outlet headers. Two pairs of vessels are shown in the connected configuration and one pair of vessels is shown prior to connection.

FIG. 6 is a perspective view of the assemblage of modular vessels of FIG. 5 showing all three pairs of vessels in a connected configuration.

### DETAILED DESCRIPTION OF THE INVENTION

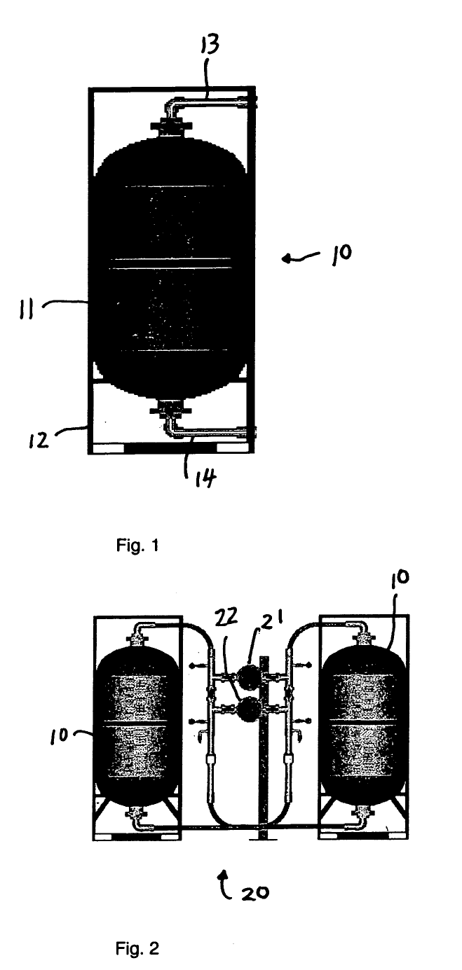

With respect to FIGS. 1-6, the preferred embodiments of the present invention may be described. The method the present invention employs a modular system that is cost effective, simple, flexible and expandable. The system may include single or multiple modular absorption vessels. No on-site chemical usage or storage is required. Waste is not generated on-site, therefore no transportation or storage of waste is required and environmental liability is limited. The modules serve as on-site service vessels and shipping containers for off-site regeneration. Exhausted vessels are exchanged with regenerated replacements.

By using modular vessels connected with a modular header system, a wide range of flow rates can be accommodated. The modular vessels can be connected in various configurations depending on the needs at a particular facility or a particular time. The modular vessels can be mounted on skids or in a trailer for short or long term service. Further, the modular vessels can be expanded in increments to meet any flow rate requirements. By using a modular system, installation of additional modular vessels is expedited.

As an alternative, exhausted media can be removed from the modules and shipped to a central regeneration facility in shipping totes. Shipping totes can also be used for storage of spare media.

Further, the modular system of the present invention can be used with non-regenerable media. The exhausted media can be shipped to a central facility for disposal in order to avoid on-site waste disposal problems.

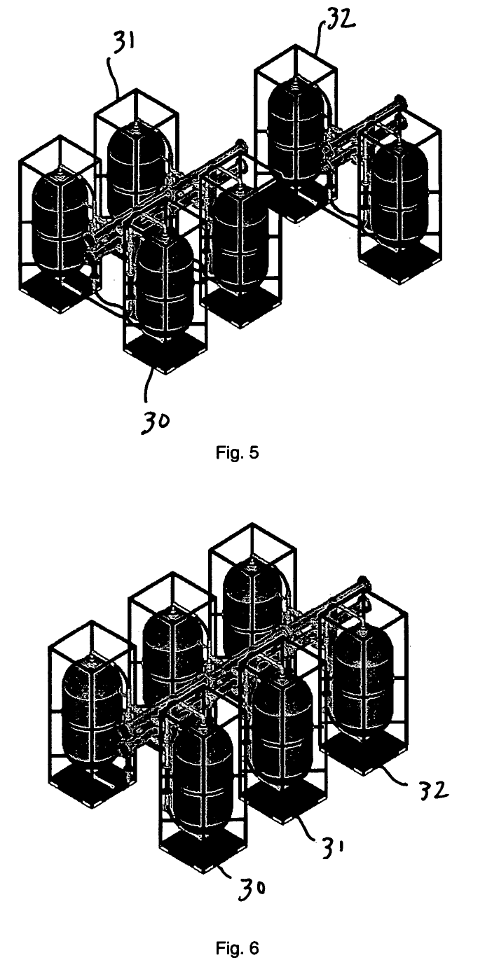

A single palletized modular vessel 10 is shown in FIG. 1. The palletized modular vessel 10 comprises a vessel 11 for containing absorption media, a pallet 12 for containing the vessel 11, an inlet 13 and an outlet 14. As can be seen from FIG. 2, the palletized modular vessels 10 can be provided in palletized pairs 20 with a modular header for each such pair 20. Single modular vessels can also be provided with a modular header. The modular header comprises an inlet header pipe 21 and an outlet header pipe 22. The inlet and outlet pipes 21, 22 can be connected to an adjacent modular header for adjacent modules, thereby allowing any number of palletized modular vessels to be interconnected. The connection between adjacent modular headers may be by any method of interconnection known to those skilled in the art. FIG. 5 shows two pairs of interconnected modular vessels 30, 31 and a additional pair of modular vessels 32 before connection. FIG. 6 shown the pair of modular vessels 32 after connection to the pre-existing configuration of modular vessels 30, 31.

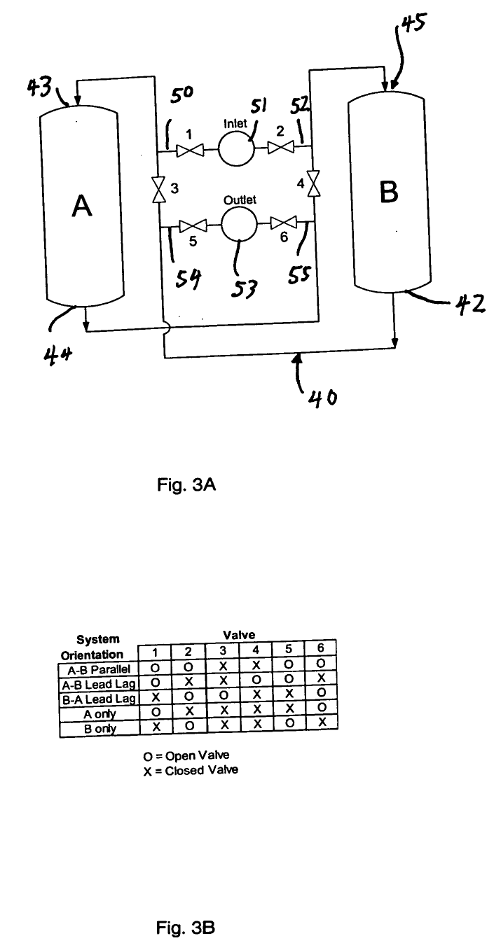

In addition to connection to the modular headers, the modular vessels may be interconnected among themselves by other piping so as to provide flow configurations as appropriate for a particular installation. As shown in FIG. 3A, the modular vessels A, B in a pair of modular vessels may be connected by first piping 40 from the outlet 42 of vessel B to the inlet 43 of vessel A. Second piping 41 connects the outlet 44 of vessel A to the inlet 45 of vessel B. A valve 3 is placed in piping 40 intermediate between the inlet 43 of vessel A and the outlet 42 of vessel B. Similarly, a valve 4 is placed intermediate between the inlet 45 of vessel B and the outlet 44 of vessel A. First inlet header piping 50 is operatively connected between inlet header 51 and a point between inlet 43 of vessel A and valve 3. Second inlet header piping 52 is operatively connected between inlet header 51 and a point between inlet 45 of vessel B and valve 4. Likewise for outlet header 53, first outlet header piping 54 is operatively connected between outlet header 53 and a point between outlet 42 of vessel B and valve 3. Second outlet header piping 55 is operatively connected between outlet header 53 and a point between outlet 44 of vessel A and valve 4.

To complete the valving arrangement, a valve 1 is placed in first inlet header piping 50, a valve 2 is placed in second inlet header piping 52, a valve 5 is placed in first outlet header piping 54 and a valve 6 is placed in second outlet header piping 55.

As shown in FIG. 3B, various flow configurations between vessel A and vessel B are possible by opening or closing various combinations of valves 1, 2, 3, 4, 5, 6. For example, lead-lag or serial configurations, where the outlet from one vessel is connected to the inlet of the other vessel, is possible with either vessel A or vessel B in the lead position. Such a configuration may be employed to improve treatment efficiency but reduced flow capacity. Alternatively, vessels A, B may be connected in parallel where respective inlets and outlets are connected to respective inlet and outlet header pipes for maximum capacity at the expense of reduced treatment efficiency. Various combinations of these two basic configurations can be used as appropriate for a particular installation or a particular situation. For example, greater flows may be required in certain time of the year and in that case a parallel configuration may be used. When arsenic levels are higher and greater treatment efficiency is necessary, the modules can be easily reconnected to provided a configuration with lead-lag flow paths.

In applications where only one vessel is required, a two-vessel lead-lag configuration may be suitable to eliminate the risk of leakage after exhaustion of the primary vessel and to provide spare absorption media on-site. When the lead vessel is exhausted, it is taken out of service to be regenerated and a freshly regenerated vessel becomes the new lag unit or polisher. The lead vessel may be intentionally overrun after initial breakthrough to achieve enhanced media loading.

The present invention has the advantage of flexibility. It is not uncommon for a municipality, water district, or the like with multiple wells to vary the flows per well due to changing arsenic levels, groundwater availability, or for other reasons. The modular vessels and header sections of the present invention can easily be moved from one well site to another.

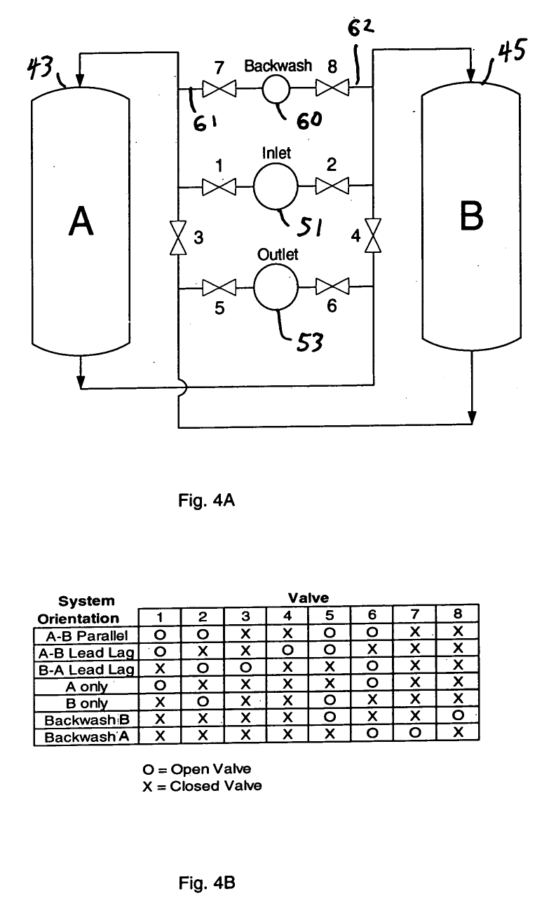

An alternative embodiment of the present invention incorporating backwash capability is described with reference to FIGS. 4A and B. As shown in FIG. 4A, a valving arrangement as described above with reference to FIG. 3A is enhanced by the addition of a modular backwash header 60. First backwash header piping 61 is operatively connected between backwash header 60 and a point between inlet 43 of vessel A and valve 3. Second backwash header piping 62 is operatively connected between backwash header 60 and a point between inlet 45 of vessel B and valve 4. As shown in FIG. 4B, the addition of the backwash valving arrangement allows the vessels to be connected in lead-lag or parallel configuration as heretofore described and also to be connected to backwash either vessel A or vessel B. As would be known to those skilled in the art, automatic valves can be employed for automatic backwashing. Backwash capability is particularly important to certain types of media, including without limitation, BIRM, activated carbon, filtration media, and granular ferric media.

In the case of regenerable media, the present invention allows a simple implementation of upflow regeneration, which has the benefits of high quality effluent in service and a highly concentrated regenerant, because the media remains in place in the vessel rather than being mixed while being pumped to and from shipping containers.

Although the present invention has been described with particular reference to arsenic removal, the present invention is not so limited and may be employed with various other types of water treatment media, for example without limitation, activated carbon, and iron and manganese removal media.

What is claimed is:

1. A method for removing arsenic from potable water at a water supply facility wherein the potable water is characterized by a variable flow rate and a variable arsenic loading, comprising the steps of:
providing at the water supply facility at least one pair of palletized vessels comprising a first vessel and a second vessel, each of said vessels containing arsenic removal media, a modular inlet header operatively connected to said first vessel and to said second vessel, a modular outlet header operatively connected to said first vessel and to said second vessel;
adding adjacent pairs of palletized vessels comprising respective first and second vessels and connecting said adjacent pairs of palletized vessels through their respective inlet and outlet headers as required to treat the potable water at a given flow rate and arsenic loading;
connecting said first and second vessels of each pair of palletized vessels in serial or parallel configuration as required to treat the potable water at a given flow rate and arsenic loading;
reconfiguring water flow among said vessels as required by variations in flow rate and arsenic loading;
operating said vessels by passing the potable water through the vessels; and
as required by the exhaustion of the arsenic removal media in a vessel, transporting such vessel to a central site for regeneration and disposal of waste from the regeneration process and/or disposal of the exhausted arsenic removal media, and replacing such vessel at the water supply facility with a replacement vessel.

2. The method of claim 1, where each of said pairs of palletized vessels further comprise a modular backwash header operatively connected to said first vessel and to said second vessel.

3. The method of claim 1, wherein each of said pairs of palletized vessels further comprise,
said first vessel having a first inlet and a first outlet;
said second vessel having a second inlet and a second outlet;
a first pipe operably connecting said first inlet to said second outlet, said first pipe having a first valve intermediate to said first inlet and said second outlet;
a second pipe operably connecting said second inlet to said first outlet, said second pipe having a second valve intermediate to said second inlet and said first outlet;
a first inlet header pipe operatively connected between said modular inlet header and a point on said first pipe between said first inlet and said first valve, and a second inlet header pipe operatively connected between said modular inlet header and a point on said second pipe between said second inlet and said second valve;
a first outlet header pipe operatively connected between said modular outlet header and a point on said first pipe between said first outlet and said first valve, and a second outlet header pipe operatively connected between said modular outlet header and a point on said second pipe between said first inlet and said second valve;
a third valve in said first inlet header pipe;
a fourth valve in said second inlet header pipe;
a fifth valve in said first outlet header pipe; and
a sixth valve in said second outlet header pipe.

4. The method claim 2, wherein each of said pairs of palletized vessels further comprise,
a first backwash header pipe operatively connected between said modular backwash header and a point on said first pipe between said first inlet and said first valve, and a second backwash header pipe operatively connected between said modular backwash header and a point on said second pipe between said second inlet and said second valve;
a seventh valve in said first backwash header pipe; and
an eight valve in said second backwash header pipe.
